(19) United States
(12) Patent Application Publication
(10) Pub. No.: US 2011/0001297 A1
(43) Pub. Date: Jan. 6, 2011

(54) Method of making an ice skate blade

(76) Inventors: Ivan Labonté, Montreal (CA); Sébastien Dubois, St-Jerome (CA); Peter Liu, Taichung (TW)

Correspondence Address: DOWELL & DOWELL P.C., 103 Oronoco St., Suite 220, Alexandria, VA, 22314, US

(21) Appl. No.: 12/458,246

(22) Filed: Jul. 6, 2009

(51) Int. Cl. A63C 1/02; B23P 11/00; A63C 1/42

(52) U.S. Cl. 280/11.12; 29/428

(57) ABSTRACT

A method of making an ice skate blade that comprises providing an upper member made of aluminum and a bottom member made of stainless steel. The upper member has a bottom portion comprising one of a recess and a projection and a top portion having attachment portions for allowing attachment of the upper member to a blade holder. The bottom member has a top portion comprising the other one of a recess and a projection and a bottom portion having a surface for contacting ice. The method further comprises joining the upper member and the bottom member together by registering the one of a recess and a projection of the upper member with the other one of a recess and a projection of the bottom member for making the blade.

### FIELD OF THE INVENTION

The present invention relates to a method of making an ice skate blade that is formed of a stainless steel bottom member and an aluminum upper member.

### BACKGROUND OF THE INVENTION

Ice skates are used in many sports, such as figure skating, speed skating and hockey, among others. Ice-skates generally include a boot for receiving a skater's foot, and a blade for contacting the ice. The boot can be made of leather, plastic or a combination of leather, plastic and composite materials. The ice skate blade is commonly made out of steel, which is known to provide durability, high skating performance and a good sharpening life.

Over time, the blade surface that contacts the ice can become dull and worn-out. In addition, many skaters have a preference for the shape of the bottom edge of the blade that contacts the ice. Sharpening the blade and/or providing a particular shape/profile for the blade involves removing a thin layer of the material from the blade's surface. Stainless steel is a commonly used for ice skate blades since it can be sharpened and/or contoured many times before the blade is completely worn out and needs to be replaced.

However, a deficiency with stainless steel blades is that they are quite heavy. For most skaters, a lighter weight ice skate is desirable. Given that the stainless steel blade contributes significantly to the overall weight of the ice skate, one of the regions where weight reduction can be achieved is in reducing the weight of the blade.

U.S. Pat. No. 6,761,363 issued on Jul. 13, 2004 discloses an ice skate blade made of stainless steel and having a recessed region with a recessed surface on each side and a polymeric material covering at least a portion of each recessed region. While this blade is lighter from a blade entirely made of stainless steel, there is still a need in the industry for a method of manufacturing an improved light weight ice-skate blade.

### SUMMARY OF THE INVENTION

In accordance with a broad aspect, the present invention provides a method of making an ice skate blade that comprises providing an upper member made of aluminum and a bottom member made of stainless steel. The upper member has a bottom portion comprising one of a recess and a projection and a top portion having attachment portions for allowing attachment of the upper member to a blade holder. The bottom member has a top portion comprising the other one of a recess and a projection and a bottom portion having a surface for contacting ice. The method further comprises joining the upper member and the bottom member together by registering the one of a recess and a projection of the upper member with the other one of a recess and a projection of the bottom member for making the blade.

In accordance with another broad aspect, the present invention provides an ice skate blade manufactured according to the method outlined above.

In accordance with a further broad aspect, the present invention provides a method of making an ice skate blade that comprises providing an upper member made of a first metallic material and a bottom member made of a second metallic material. The second metallic material has a density higher from the one of the first metallic material. The upper member has a bottom portion comprising one of a recess and a projection and a top portion having attachment portions for allowing attachment of the upper member to a blade holder. The bottom member has a top portion comprising the other one of a recess and a projection and a bottom portion having a surface for contacting ice. The method further comprises joining the upper member and the bottom member together by registering the one of a recess and a projection of the upper member with the other one of a recess and a projection of the bottom member for making the blade.

Other aspects and features of the present invention will become apparent to the persons skilled in the art upon review of the following description of embodiments of the invention in conjunction with the accompanying figures.

### BRIEF DESCRIPTION OF THE DRAWINGS

A detailed description of the embodiments of the present invention is provided herein below, by way of example only, with reference to the accompanying drawings, in which:

FIG. 1 shows an upper member and a bottom member of an ice skate runner in an un-assembled state according to a non-limiting example of implementation of the present invention;

FIG. 2 shows the upper member and the bottom member of the ice skate runner of FIG. 1 in an assembled state;

FIGS. 3A through 3D show cross sectional views of four different non-limiting embodiments of an ice skate runner in accordance with the present invention;

FIGS. 4A and 4B show cross sectional views of two different non-limiting embodiments of holes that can be applied to an ice skate runner according in accordance with the present invention;

FIGS. 4C and 4D show a cross sectional views of non-limiting examples of ice skate runners according to the present invention that are affixed together via mechanical fasteners;

FIG. 5 shows an upper member and a bottom member of an ice skate runner in an un-assembled state according to a second non-limiting example of implementation of the present invention;

FIG. 6 shows a flow chart of a method of manufacturing an ice skate runner in accordance with a non-limiting example of implementation of the present invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF THE EMBODIMENTS

To facilitate the description, any reference numerals designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

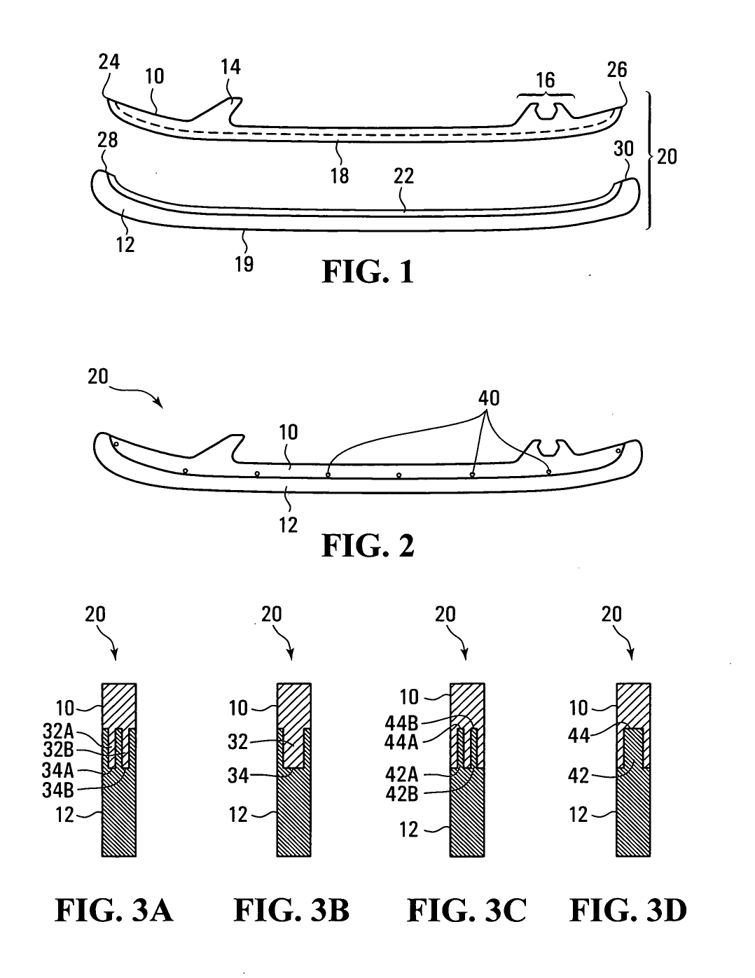

Shown in FIG. 1 is a non-limiting example of an upper member 10 and a bottom member 12 of an ice skate blade 20 in accordance with the present invention, shown in an un-assembled state. The upper member 10 is made of aluminum and the bottom member 12 is made of stainless steel. As shown, the upper member 10 comprises attachment portions 14, 16 that are suitable for attaching the upper member of the blade 20 to a blade holder. The attachment portions 14, 16 can be of any suitable shape and/or size for attaching the blade 20 to a blade holder, which in turn attaches the blade 20 to an ice skate boot (not shown). The attachment portion 14 may be a projection that is capable of registering with a corresponding recess provided in the blade holder and the attachment portion 16 may be a projection with a triangular, circular, trapezoidal or hexagonal open aperture for receiving the head of a screw having a threaded portion that is passed through an aperture provided in the blade holder for receiving a nut. The attachment portion 16 may be at least partially covered by a reinforcing sleeve made of stainless steel. The bottom member 12 includes a surface 19 for contacting the ice.

The upper member 10 includes a bottom portion 18 that comprises one of a projection and a recess, and the bottom member 12 includes an upper portion 22 that comprises the other one of a projection and a recess. As will be described in more detail below, the upper member 10 and the bottom member 12 are able to be joined together by registering the one of a projection and a recess of the upper member 10 with the other one of a projection and a recess of the bottom member 18. For example, in the case where the upper member 10 includes a projection, then the bottom member 12 includes a recess such that the recess and projection can be matingly engaged in order to join the upper member 10 and the bottom member 12 together.

In accordance with alternative embodiments, the upper member 10 and the bottom member 12 can be further affixed together by applying glue between the upper member 10 and the bottom member 12, and/or by applying one or more mechanical fasteners through the upper member 10 and the bottom member 12 in order to affix the two members 10, 12 of the blade 20 together.

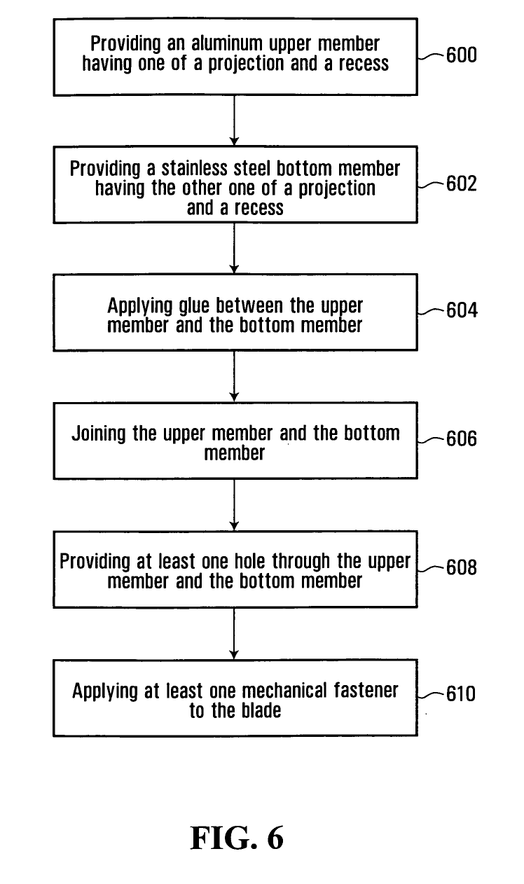

A non-limiting method of manufacturing the ice skate blade 20 according to the present invention will now be described in more detail with reference to the flow diagram of FIG. 6.

Firstly, at step 600, the method comprises providing the upper member 10 that is made of aluminum. The aluminum can be any suitable type of aluminum, and in accordance with a non-limiting embodiment, is 7075 aluminum with a T6 heat treatment. The purpose of the heat treatment operation is to give the aluminum upper member 10 a hardness of between 69 and 75 HRB. SD2024 or 6061 aluminum can also be used.

The aluminum upper member 10 can be made in a variety of different manners. In accordance with a non-limiting embodiment, the upper member 10 is made by stamping the shape of the upper member 10 into an aluminum substrate. Once the stamping operation is complete, a machining operation is then performed on the aluminum upper member 10. The machining can be done either manually, or via a CNC machine.

The machining operation is operative for producing the profile shape of the bottom portion 18 of the upper member 10, and for creating one of a projection and a recess in that bottom portion 18. As will be described in more detail below, in the case where a projection is formed into the bottom portion 18 of the upper member 10, then a corresponding recess is formed into the bottom member 12. Conversely, in the case where a recess is formed into the bottom portion 18 of the upper member 10, then a corresponding projection is formed into the bottom member 12.

In accordance with a non-limiting embodiment, the recess or the projection that is formed into the bottom surface 18 of the upper member 10 is formed along the entire length of the upper member 10. As such, the recess or projection extends from the toe portion 24 of the upper member 10 to the heel portion 26 of the upper member 10. However, in another embodiment, it is possible for the recess or projection to extend along only a portion of the length of the upper member 10. For example, a projection may simply extend intermittently along 2 inch portions of the length of the upper portion 10. Any configuration of recess and/or projections can be envisaged, so long as the projection and/or recess on the upper member 10 corresponds to a in inversely corresponding recess and/or projection on the bottom member 12.

Once the shape of the upper member 10 has been produced, the upper member 10 is exposed to ultrasonic cleansing in order to clean oil and dirt from its surface. Although ultrasonic cleansing is described herein, it should be appreciated that any cleaning technique known in the art could be used without departing from the spirit of the invention.

In accordance with a non-limiting embodiment, a heat treatment operation is performed on the aluminum upper member 10.

At step 602, the method comprises providing a bottom member 12 made of stainless steel. It should be appreciated that any suitable stainless steel known in the art could be used for the bottom member 12. In accordance with a non-limiting example, 440A stainless steel is used. SANDVIK 12C27 or AISI 420 stainless steel can also be used.

The stainless steel bottom member 12 can be made in a variety of different manners. In accordance with a non-limiting embodiment, the bottom member 12 is made by stamping the shape of the bottom member 12 into a stainless steel substrate.

Once the stamping operation is complete, several surface finishing operations may be performed on the stainless steel bottom member 12. For example, a burr removal operation is performed in order to remove burrs that remain on the surface of the stainless steel bottom member 12. The burrs can be removed using any technique known in the art, such as by belt grinding, among other possibilities.

A flattening operation and a surface polishing operation are also performed on the stainless steel bottom member 12. The flattening operation can be performed by running the stainless steel bottom member 12 through a flattening machine in order to remove any deformation that occurred during the stamping operation. The polishing operation is performed in order to create a nice surface finish on the stainless steel bottom member 12. The polishing operation can be performed manually or by a grinding machine, among other possibilities.

The stainless steel bottom member 12 is then machined into its final shape. The machining can be done either manually, or via a CNC machine.

The machining operation is operative for producing the profile shape of the upper portion 22, and for creating the other one of a projection and a recess in the bottom portion 18. As described above, the upper portion 22 of the bottom member 12 can include either a projection or a recess. Depending on whether the upper member 10 includes a projection or a recess, the bottom member 12 will include the opposite and corresponding one of a projection or a recess.

In accordance with a non-limiting embodiment, the recess or projection that is formed into the upper surface 22 of the bottom member 12 is formed along the entire length of the bottom member 12 from the toe portion 28 of the bottom member 12 to the heel portion 30 of the bottom member 12. However, in another embodiment as described above, it is possible for the recess or projection to extend along only a portion of the length of the bottom member 12.

Once the shape of the bottom member 12 has been produced, it is exposed to a heat treatment operation. Any suitable heat treatment operation can be used, such as baking, thermal compression; etc. . . . In accordance with a non-limiting example, heated plates are used to press and tightly hold the bottom portion 12. This is done in order to reduce any deformation that could have been introduced during the manufacturing process. Once this is complete, a flatness checking procedure is performed in order ensure the flatness of the bottom portion 12. Depending on the thickness of the bottom member 12, it will be checked for flatness by different bar gauges. For example, for a thickness of between 2.8 to 2.85 mm, a 3.0 bar gauge will be used, for a thickness of between 2.85 to 2.9 mm, a 3.05 bar gauge will be used, for a thickness of between 2.9 to 2.95 mm, a 3.1 bar gauge will be used and for a thickness of between 2.95 to 3.0 mm, a 3.15 bar gauge will be used.

Once ready, the bottom member 12 is also exposed to ultrasonic cleansing in order to clean the oil and dirt from its surface. Although ultrasonic cleansing is described herein, it should be appreciated that any cleaning technique known in the art could be used without departing from the spirit of the invention.

Although steps 600 and 602 are shown in FIG. 5 as being subsequent steps that occur one after the other, it should be appreciated that these steps can be reversed (such that step 602 comes before step 600) or these steps can be performed simultaneously (such that the steps of providing the upper member 10 and the bottom member 12 are performed at approximately the same time).

At step 604, glue may be applied to either the bottom portion 18 of the upper member 10 (which could be a recess or a projection) or to the upper portion 22 of the bottom member 12 (which is the opposite one of a recess or a projection). In an alternative embodiment, glue is applied to both the bottom portion 18 of the upper member 10 and the upper portion 22 of the bottom member 12. The glue can be applied using a brush or can be applied directly from a nozzle that is attached to the end of a glue container, among other possibilities.

In accordance with a non-limiting embodiment, the glue is made of an epoxy adhesive with 15 to 25% of elastomeric material. An example of an epoxy adhesive that can be used is the EVERWIDE EPOXY SD EX300B and having approximately 20% of elastomeric material. It should be appreciated that other glues could also be used without departing from the spirit of the invention.

At step 606, the upper member 10 and the bottom member 12 are joined together by registering the one of a recess and a projection of the upper member 10 with the other one of a recess and a projection of the bottom member 12. FIG. 2 shows the blade 20 once the upper member 10 and the bottom member 12 have been joined together. The joining of the two members 10, 12 can be done manually by bringing the two members together, or alternatively can be done by a machine that aligns the two members and then brings them into mating engagement with each other.

Shown in FIGS. 3A to 3D are four cross-sectional views of different embodiments of the blade 20.

In the embodiments shown in FIGS. 3A and 3B, it is the upper members 10 that include the projections and the bottom members 12 that include the recesses. More specifically, in the embodiment shown in FIG. 3A, the upper member 10 comprises two projections 32a and 32b and the bottom member 12 comprises two recesses 34a and 34b. As such, when the upper member 10 and the bottom member 12 are joined together, the two projections 32a, 32b register with the two recesses 34a, 34b.

In the embodiment of FIG. 3B, the upper member 10 comprises a single projection 32 and the bottom member 12 comprises a single recess 34. In this embodiment, when the upper member 10 and the bottom member 12 are joined together, the projection 32 registers with the recess 34.

In the embodiments shown in FIGS. 3C and 3D, it is the bottom members 12 that include the projections and the upper members 10 that include the recesses. In the embodiment shown in FIG. 3C, the bottom member 12 comprises two projections 42a and 42b and the upper member 10 comprises two recesses 44a and 44b. As such, when the upper member 10 and the bottom member 12 are joined together, the two projections 42a, 42b register with the two recesses 44a, 44b.

In the embodiment of FIG. 3D, the bottom member 12 comprises a single projection 42 and the upper member 10 comprises a single recess 44. In this embodiment, when the upper member 10 and the bottom member 12 are joined together, the projection 42 registers with the recess 44.

It should be appreciated that the upper member 10 and bottom member 12 can include any number of projections and/or recesses without departing from the spirit of the invention.

In accordance with a non-limiting embodiment, once the upper member 10 and the bottom member 12 have been joined together by registering the one of a recess and a projection of the upper member 10 with the other one of a recess and a projection of the bottom member 12, then the blade 20 can be exposed to a heat treating operation. In accordance with a non-limiting example, the joined upper member 10 and the bottom member 12 are heated to a temperature of between 130 C.° to 160 C.° for a predetermined period of time. The predetermined period of time can be based on a variety of factors such as the thickness of the blade, the type of aluminum/stainless steel that is used and the type of glue that is applied between the upper member 10 and the bottom member 12.

In accordance with a non-limiting example, the blade 20 is placed within an oven having a temperature of between 130 C.° to 160 C.° for approximately 1 hour.

At step 608, holes 40 may be made through the blade 20 along the length of the blade 20. This is best seen in FIGS. 2 and 5. As will be described in more detail below, the holes 40 are provided through the blade 20 such that they can receive mechanical fasteners or other mechanical fastening arrangements for further affixing the upper member 10 and the bottom member 20 together.

At step 610, at least one mechanical fastener may be inserted through the blade. The mechanical fasteners can be applied through the holes 40, or alternatively can be applied directly through the upper member 10 and the lower member 12.

As shown in FIG. 2, in the case where holes 40 are provided in the blade 20, these holes 40 are positioned along the length of the blade 20 in the region where the upper member 10 registers with the bottom member 12. As such, the holes 40 extend through the one of a recess and a projection of the upper member 10 and through the other one of a recess and a projection of the bottom member 12. The holes 40 can be provided via a drilling or puncturing operation.

In accordance with a non-limiting embodiment, the holes 40 have a diameter of between 1 mm and 1.5 mm and are positioned approximately at between 1.70 mm and 1.90 mm away from the bottom edge portion of the upper member 10. In addition, the spacing between the holes 40 along the length of the blade 20 can range from between 10 mm to 50 mm. For example, for a blade of 296.81 mm, the spacing between the holes may be about 27 mm. A shown in FIGS. 2 and 5, the holes 40 of the blade 20 shown in FIG. 2 are not as closely spaced together as the holes 40 of the blade 20 shown in FIG. 5.

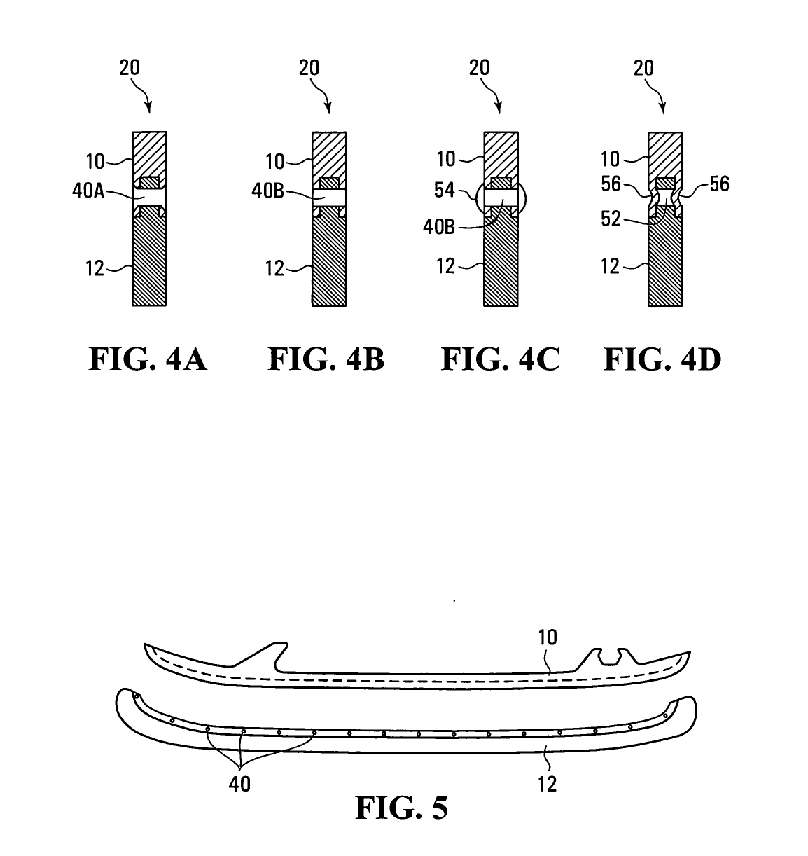

FIGS. 4A and 4B show two non-limiting cross-sectional views of different holes 40 that can be provided along the length of the blade 20. FIG. 4A shows a hole 40a that includes a small chamfer or countersink at either end. The countersinks can be included in order to allow mechanical fasteners that are inserted therein to lie flush, or close to flush, with the side of the blade 20. FIG. 4B includes a hole 40b that extends straight through the upper member 10 and the bottom member 12 without having a countersink.

As indicated above, step 610 involves applying at least one mechanical fastener to the blade 20. FIG. 4C shows a cross sectional view of a blade 20 through which a mechanical fastener 54 has been inserted. As shown, the mechanical fastener 54 extends through both the upper member 10 and the bottom member 12 of the blade 20.

In the embodiment shown in FIG. 4C, the mechanical fastener 54 is in the form of a rivet. The rivet can be made of brass, steel or aluminum among other possibilities.

In one embodiment, the mechanical fasteners 54 are rivets made of stainless steel (e.g. SUS303). It should however be appreciated that any other form of mechanical fastener, such as a screw, nut and bolt, weld point, or other mechanical fastener could also be used without departing from the spirit of the invention.

In the embodiment shown in FIG. 4C, the heads of the rivet extend past the sides of the blade 20. It should be appreciated that in an alternative embodiment, the rivets may be shaped such that they are flush with the surface of the blade 20. For example, this may be the case when the rivets are inserted into holes 40a that include a chamfer or countersink. In one embodiment, the blade may comprise between 8 to 12 rivets.

In yet a further embodiment, as shown in FIG. 4D, it is possible that no additional mechanical fastener is used, but that the upper member 10 and the bottom member 12 together form a mechanical fastening arrangement. For example, in the embodiment of FIG. 4D, the projection of the bottom member 12 includes a hole 52 therein. The hole 52 is drilled, or otherwise provided in the projection, prior to the upper member 10 being joined to the bottom member 12. Once the upper member 10 and the bottom member 12 are joined together, the side edges of the upper member 10 are crimped inwards at the regions where the holes 52 are located. In this manner, the upper member 10 and the bottom member 12 are crimped together, thereby forming a mechanical fastening arrangement without the need for separate mechanical fasteners.

In the case where mechanical fasteners are applied to the blade 20 at step 610, it is possible that these mechanical fasteners can puncture through the blade without having to be placed through pre-formed holes 40. For example, it is possible that the rivets can be pushed through the blade 20 without having to be applied through pre-existing holes. In such a case, step 608 of providing holes is not necessary.

Once the blade 20 has been assembled, such that the upper member 10 and the bottom member 12 are affixed together (which may be done via glue and/or mechanical fasteners), the blade 20 is polished to a hairline finish. This may involve removing any protruded rivets (or other mechanical fastener), removing any surface irregularities and trimming the blade to its final thickness.

Referring back to FIG. 2, there is shown an assembled ice skate blade 20 that has been manufactured in accordance with the method of the present invention. The ice skate blade 20 that has been manufactured as described above, is relatively light weight and has an average density of approximately 4.0 g/cm³ and 5.5 g/cm³. For example, for a blade with a length of 296.81 mm, a thickness of 3 mm, a total height of 15.89 mm, and ten stainless steel rivets joining the upper and lower members, the average density will be 5.4 g/cm³ for a 11.6 mm height of the stainless steel member, 4.58 g/cm³ for a 8.6 mm height of the stainless steel member, and 4.09 g/cm³ for a 6.6 mm height of the stainless steel member. The density of the ice skate blade can be around or below 4.00 g/cm³ with a stainless steel member having a height of less than 6 mm.

Although the present invention has been described as being a method for manufacturing an ice skate blade out of an aluminum upper member 10 and a stainless steel bottom member 12, it should be appreciated that other materials could be used. For example, the upper member can be made of a first metallic material and the bottom member 12 can be made of second metallic material, wherein the density of the first metallic material is less from the one of the second metallic material.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A method of making an ice skate blade comprising:
(a) providing an upper member made of aluminum, the upper member having a bottom portion comprising one of a recess and a projection and a top portion having attachment portions for allowing attachment of the upper member to a blade holder;
(b) providing a bottom member made of stainless steel, the bottom member having a top portion comprising the other one of a recess and a projection and a bottom portion having a surface for contacting ice; and
(c) joining the upper member and the bottom member together by registering the one of a recess and a projection of the upper member with the other one of a recess and a projection of the bottom member for making the blade.

2. A method as defined in claim 1, further comprising applying glue on either the one of a recess and a projection of the upper member and the other one of a recess and a projection of the bottom member, prior to joining the upper member and the bottom member together.

3. A method as defined in claim 2, comprising applying glue on both the one of a recess and a projection of the upper member and the other one of a recess and a projection of the bottom member.

4. A method as defined in claim 2, wherein the glue comprises an epoxy adhesive and between 15 and 25% of elastomeric material.

5. A method as defined in claim 1, wherein the one of a recess and a projection of the upper member extends along a length of the blade.

6. A method as defined in claim 5, wherein the other one of a recess and a projection of the bottom member extends along the length of the blade.

7. A method as defined in claim 2, further comprising heating the upper member and bottom member to a temperature of between 130 C.° and 160 C.° for a pre-determined period of time.

8. A method as defined in claim 7, wherein the pre-determined period of time is approximately 1 hour.

9. A method as defined in claim 2, further comprising applying at least one mechanical fastener passing through the blade.

10. A method as defined in claim 9, wherein applying at least one mechanical fastener comprises applying at least one rivet.

11. A method as defined in claim 9, further comprising providing for each of the at least one mechanical fastener a respective hole through which the at least one mechanical fastener can be inserted.

12. A method as defined in claim 1, wherein providing the upper member comprises performing at least one of a stamping operation and a machining operation on an aluminum substrate.

13. A method as defined in claim 1, wherein providing the bottom member comprises performing at least one of a stamping operation and a machining operation on a stainless steel substrate.

14. A method as defined in claim 1, further comprising performing a heat treatment operation on at least one of the upper member and the bottom member, prior to joining the upper member and the bottom member together.

15. An ice skate blade made according to the method as defined in claim 9.

16. An ice skate blade as defined in claim 15, having less than 10 fasteners and an average density of between 4.0 g/cm³ and 5.4 g/cm³.

17. A method of making an ice skate blade comprising:
(a) providing an upper member made of a first metallic material with a first density, the upper member having a bottom portion comprising one of a recess and a projection and a top portion having attachment portions for allowing attachment of the upper member to a blade holder;
(b) providing a bottom member made of a second metallic material with a second density being higher from the first density, the bottom member having a top portion comprising the other one of a recess and a projection and a bottom portion having a surface for contacting ice; and
(c) joining the upper member and the bottom member together by registering the one of a recess and a projection of the upper member with the other one of a recess and a projection of the bottom member for making the blade.

18. A method as defined in claim 17, further comprising applying glue on either the one of a recess and a projection of the upper member and the other one of a recess and a projection of the bottom member, prior to joining the upper member and the bottom member together.

19. A method as defined in claim 17, comprising applying glue on both the one of a recess and a projection of the upper member and the other one of a recess and a projection of the bottom member.

20. A method as defined in claim 19, further comprising applying at least one mechanical fastener passing through the blade.

21. A method as defined in claim 20, wherein applying at least one mechanical fastener comprises applying at least one rivet.

22. A method as defined in claim 20, further comprising providing for each of the at least one mechanical fastener a respective hole through which the at least one mechanical fastener can be inserted.

23. An ice skate blade made according to the method as defined in claim 17.

24. A method as defined in claim 1, further comprising applying at least one mechanical fastener passing through the blade.

25. A method as defined in claim 24, wherein applying at least one mechanical fastener comprises applying at least one rivet.

26. A method as defined in claim 25, further comprising providing for each of the at least one rivet a respective hole through which the at least one mechanical fastener can be inserted.

27. An ice skate blade made according to the method as defined in claim 19.

28. An ice skate blade made according to the method as defined in claim 20.

29. An ice skate blade as defined in claim 28, having less than 10 fasteners and an average density of between 4.0 g/cm³ and 5.4 g/cm³.
